(19) United States
(12) Patent Application Publication
(10) Pub. No.: US 2022/0097222 A1
(43) Pub. Date: Mar. 31, 2022

(54) BEVEL GRINDING ADJUSTABLE TOOL REST

(71) Applicants: Daniel Thomas Berg, Baldwin, NY (US); Jason Norman Northgard, South Huntington, NY (US)

(72) Inventors: Daniel Thomas Berg, Baldwin, NY (US); Jason Norman Northgard, South Huntington, NY (US)

(21) Appl. No.: 16/948,775

(22) Filed: Sep. 30, 2020

(51) Int. Cl. B25H 1/02; B24B 41/06

(52) U.S. Cl. CPC B25H 1/02; B24B 41/06

(57) ABSTRACT

An adjustable table that operatively associates with a bevel grinder so that knife makers can grind bevels with the belt grinder, while keeping the knife blade flat on the adjustable table. The adjustable table can adjust vertically, laterally, and angularly relative to the grinder belt.

### BACKGROUND OF THE INVENTION

The present invention relates to knife making and, more particularly, a tilt table knife bevel grinding tool rest/jig.

Knife makers grind bevels with a belt grinder, either freehand or with the use of a bevel jig. Freehand grinding gives the blade smith the most flexibility and as a technique can be used to create flat, hollow and recurved bevels, but the process can take years to master and is very time consuming. Furthermore, currently available bevel jigs are rigid, and so only produce one type of bevel.

Most knife bevel jigs clamp the knife into the jig which then slides across a 90-degree table. This type of jig creates bevels that do not follow the profile of the knife blank but rather produce only straight bevels parallel to the work surface. Thus, these jigs work for creating flat bevels but cannot be used for recurved bevels or hollow grinds, and they also do not permit the bevel to follow the profile of the blade because they only travel along the horizontal axis of the 90-degree table. To date, this design is the most common in the industry.

Likewise, a standard hollow grinding jig is rigidly mounted to a belt grinder and works in conjunction with a large wheel. The knife slides into this jig from either side. A screw on the back of the jig is dialed to provide tension forcing the blade into the belt while the knife maker pulls the blank through the jig from side to side. This jig only works hollow grinds not for flat bevels or recurved bevels.

In short, current bevel jigs are not capable of producing both flat and hollow ground bevels.

As can be seen, there is a need for a tilt table knife bevel grinding tool rest/jig. Using the tilt table embodied in the present invention allows knife makers to visualize the edge of the blade and visually grind to scribed center lines. By doing this the knife bevels will follow the shape or profile of the blank.

Knife makers using the present invention, colloquially known as ‘Tilt Table’, move the knife while keeping the blade flat on the table. This contrasts with most existing jigs which have the knife clamped to the jig and then the entire assembly is moved across the grinding surface of the belt grinders belt.

As a result, the present invention can be used to grind flat, hollow ground and recurved bevels. It adjusts vertically, horizontally and can easily adjust to any desired bevel angle. The tilt table also has a rocking plate to allow the device to be squared to the grinding surface. Using the tilt table allows knife makers to easily and accurately grind bevels while not clamping the knife blank to a jig or losing any of the artistic control achieved by experienced free hand grinding.

The present invention is also adapted to fit a variety of manufacturers 2×72 belt grinders. It can be used on both flat, hollow and recurve bevels.

### SUMMARY OF THE INVENTION

In one aspect of the present invention, an adjustable table assembly for supporting bevel grinding blanks includes the following: an angle bracket having a first leg and a second leg oriented transverse the first leg; along the first leg, a bracket pivot hole spaced apart from an adjustment hole by a first distance; and longitudinally along the second leg, a lateral alignment slot an attachment arm plate having: a vertical leg connected to a horizontal leg; along the vertical leg, one or more vertical slots extending longitudinally along the vertical leg; and along the horizontal leg, a plate pivot hole and an arcuate slot radially spaced apart from the plate pivot hole by the first distance; and a tilt table extending between a tip edge and a lower edge, the tilt table comprising: a plurality of lateral alignment holes spaced apart inward of a lower edge of the tilt table.

In another aspect of the present invention, the adjustable table assembly for supporting bevel grinding blanks including the following: an angle bracket having: a first leg and a second leg oriented transverse the first leg; along the first leg, a bracket pivot hole spaced apart from an adjustment hole by a first distance; and longitudinally along the second leg, a lateral alignment slot; an attachment arm plate having: a vertical leg connected to a horizontal leg; along the vertical leg, one or more vertical slots extending longitudinally along the vertical leg; and along the horizontal leg, a plate pivot hole and an arcuate slot radially spaced apart from the plate pivot hole by the first distance; and a tilt table having: a tip edge and a lower edge opposing the tip edge; a plurality of lateral alignment holes spaced apart inward of a lower edge of the tilt table; a belt cutout in a center of the tip edge; a beveled edge along a lower portion of the belt cutout; a pivot fastener interconnecting said pivot holes so that the angle bracket rotates relative the attachment arm plate about the pivot fastener; a lock down lever selectively securing one of a plurality of portions of the arcuate slot to the adjustment hole; one or more lateral alignment fasteners through the lateral alignment slot and operatively associating with one or more of the plurality of lateral alignment holes; a plurality of corner holes in the second leg; and a plurality of square-up fasteners dimensioned to secure to an inner surface of the tilt table through the plurality of corner holes.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention shown in use;

FIG. 2 is a front elevation view of an exemplary embodiment of the present invention shown in use;

FIG. 3 is a section view of an exemplary embodiment of the present invention, taken along line 3-3 in FIG. 1;

FIG. 4 is a perspective view of an exemplary embodiment of the present invention, with the table shown in a vertical orientation;

FIG. 5 is an exploded perspective view of an exemplary embodiment of the present invention;

FIG. 6 is a side elevation view of an exemplary embodiment of the present invention, illustrating the angle of incidence adjustability;

FIG. 7 is a rear elevation view of an exemplary embodiment of the present invention, illustrating the lateral adjustability;

FIG. 8 is a section view of an exemplary embodiment of the present invention, taken along line 8-8 in FIG. 7, illustrating table alignment;

FIG. 9 is a section view of an exemplary embodiment of the present invention, taken along line 8-8 in FIG. 7, further illustrating table alignment;

FIG. 10 is a section view of an exemplary embodiment of the present invention, taken along line 10-10 in FIG. 7;

FIG. 11 is a perspective view of an exemplary embodiment of the present invention; and

FIG. 12 is a section view of an exemplary embodiment of the present invention, taken along line 12-12 in FIG. 11.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an adjustable table that operatively associates with the bevel grinder so that knife makers can grind bevels with a belt grinder, while keeping the knife blade flat on the adjustable table. The adjustable table can adjust vertically, laterally, and angularly relative to the grinder belt.

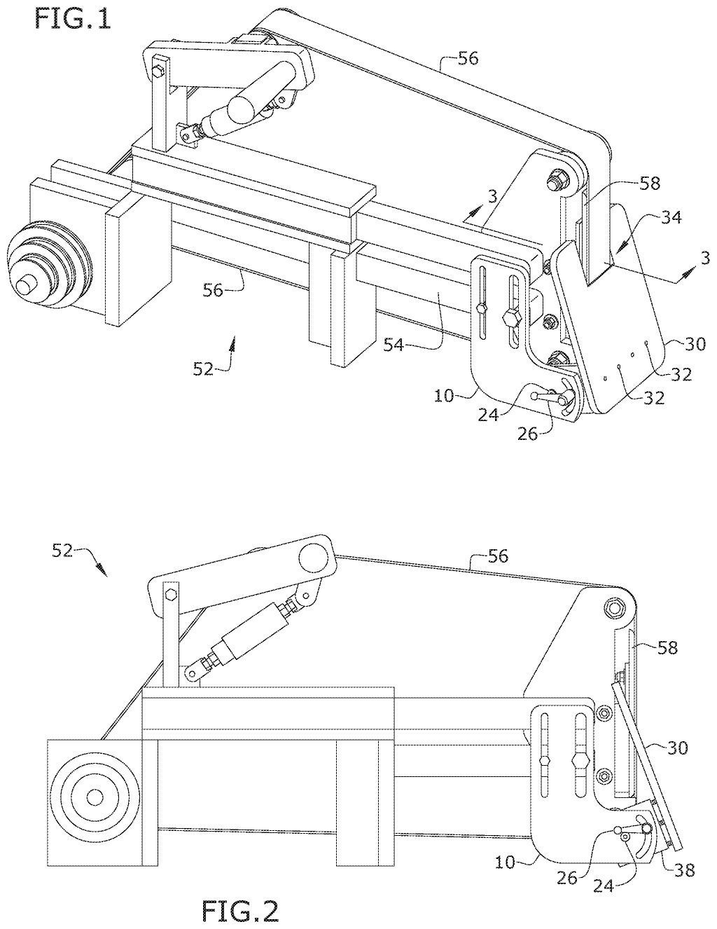

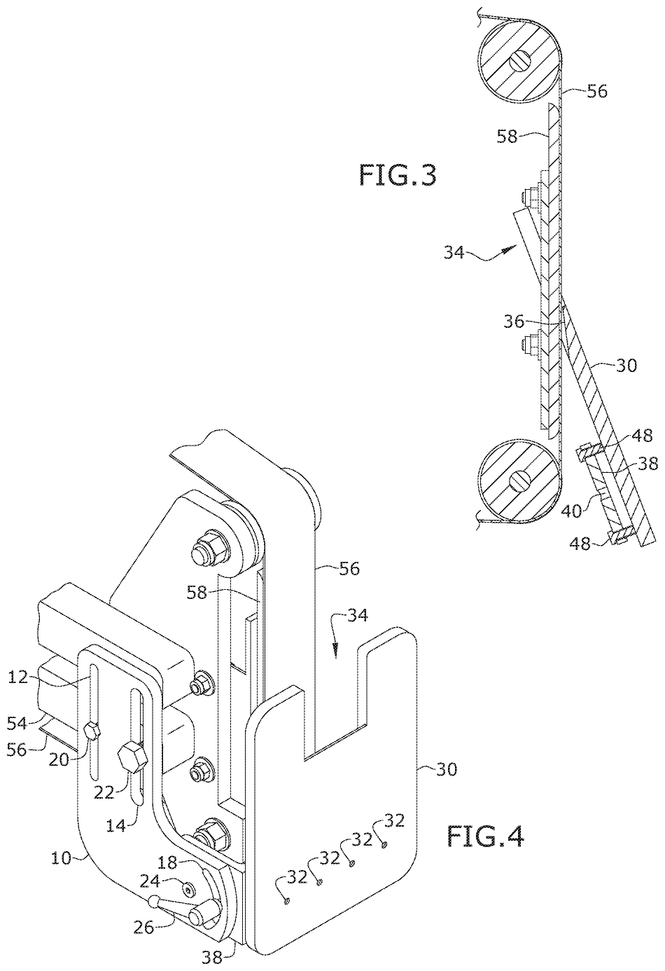

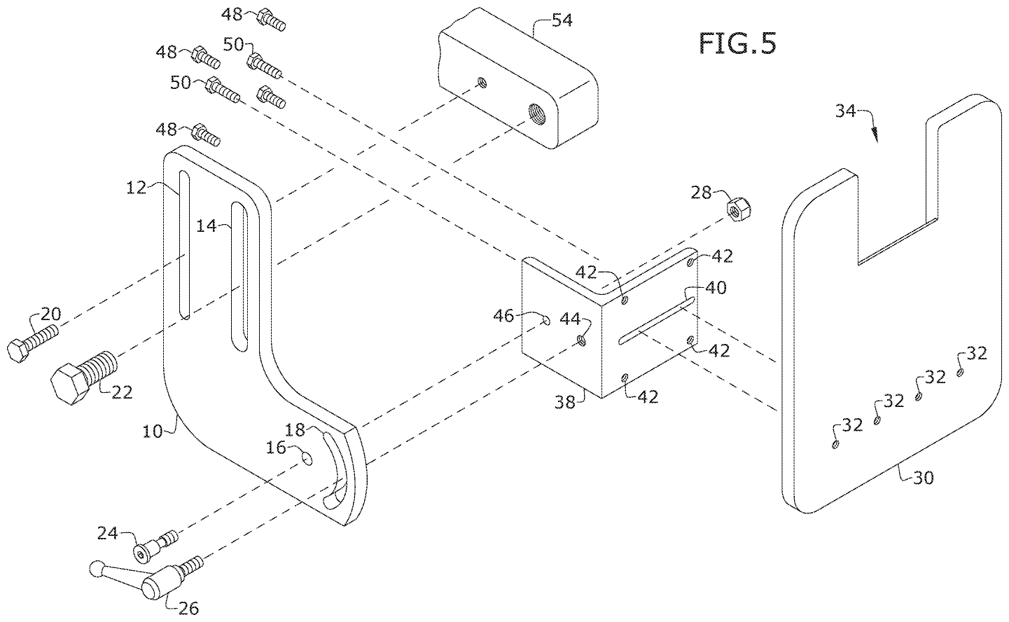

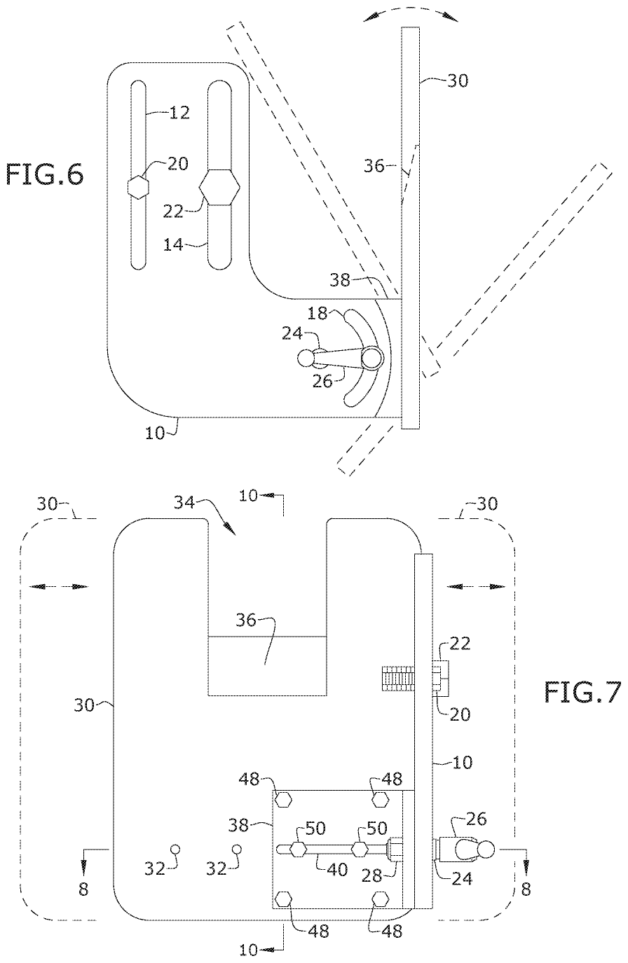

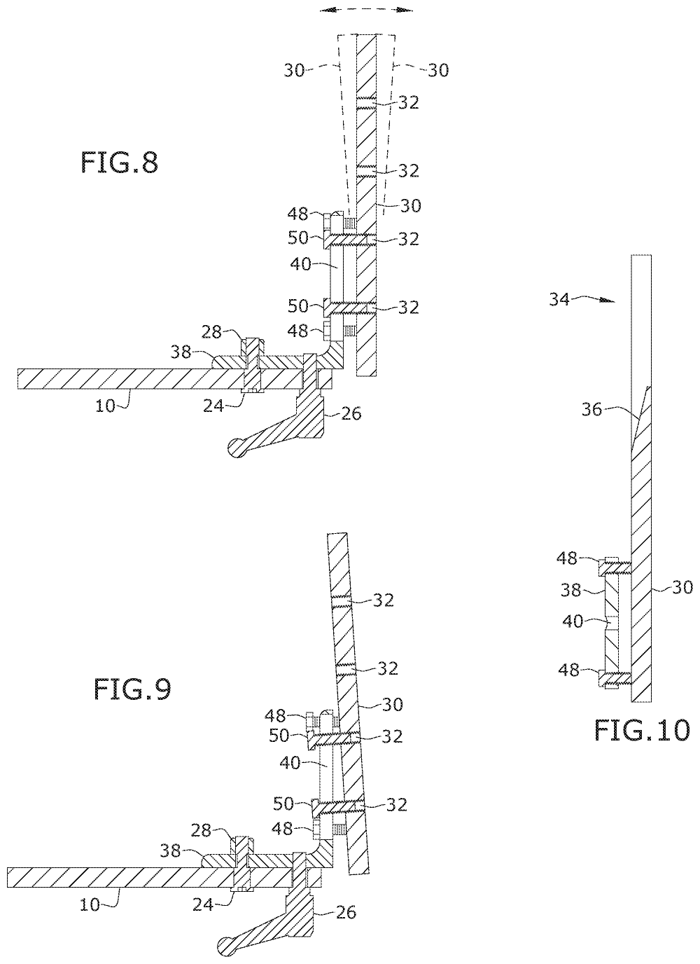

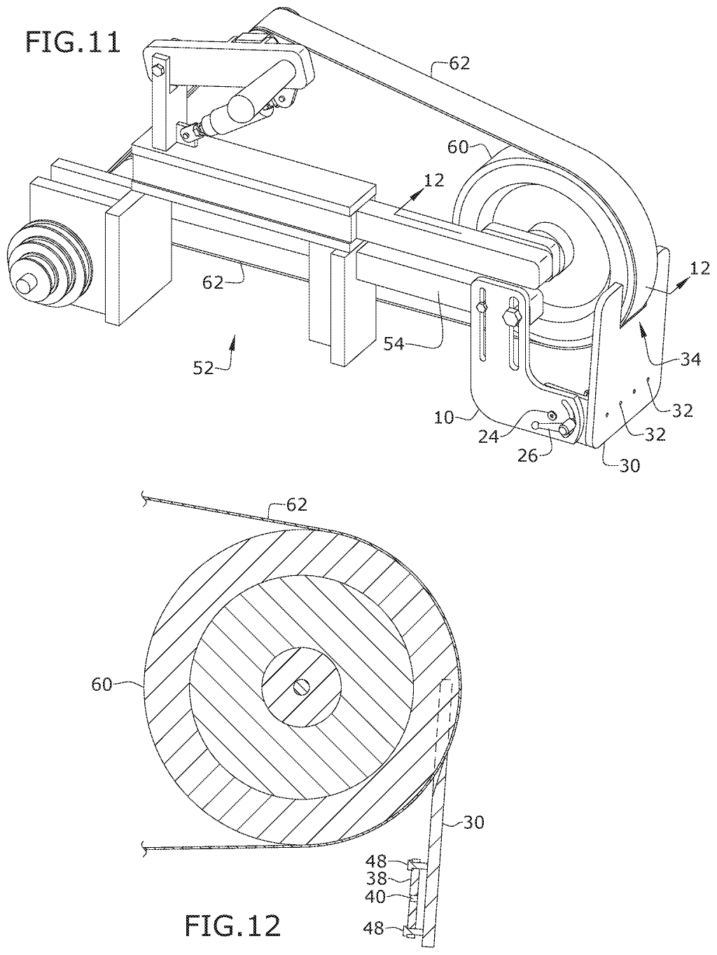

Referring now to FIGS. 1 through 12, the present invention may include a flat tilt table 30, an angle bracket 38, and an attachment arm plate 10.

The tilt table 30 may be made of any material to provide sufficient strength not to flex. The tilt table 30 extends from a tip edge to a lower edge. A belt cutout 34 in the center of a tip edge of the tilt table 30 is large enough to accommodate a grinder platen 58 and associated platen grinder belt 56 or grinder wheel 60 and an associated belt grinders belt 62. The belt cutout 34 may have a relieved or beveled edge 36 on the inner surface to allow close fit to the grinding belt 56 or 62 without contact.

Inward of the lower edge, typically just along an inner surface of the table 30, tap holes (not shown) may be provided for rigidly connecting the angle bracket 38 by way of square-up fasteners 48. Spaced laterally apart between the tap holes are lateral alignment holes 32 for selectively engaging lateral alignment fasteners 50 through the angle bracket 38.

The angle bracket 38 may be L-shaped, providing a first leg and an orthogonal second leg. The second leg provides corner holes 42 that align with the above-mentioned tap holes for properly engaging the square-up fasteners 48. A centrally disposed lateral alignment slot 40 aligns with the above-mentioned lateral alignment holes 32 for effectuating the lateral alignment of the table 30 as the lateral alignment fasteners 50 are enabled to be used selectively along the lateral alignment slot 40. The lateral alignment slot 40 may be a milled slot to further facilitate the lateral alignment/horizontal centering on variety of different manufacturers grinders. The lateral alignment/horizontal centering facilitates lateral, side-to-side selective adjustments of the table 30, as illustrated in FIG. 7, for squaring the table 30 to working surfaces or structure 54 of grinder belt 56 or 62.

The second leg may provide a bracket pivot hole 46 spaced apart from an angle-adjustment hole 44, for facilitating selective angular adjustments of the angle bracket 38 relative to the attachment arm plate 10.

The attachment arm plate 10 may be made of any material providing sufficient thickness not to flex during the use contemplated herein. The attachment arm plate 10 may have a planar L-shape or J-shape, having a vertical leg and a horizontal leg. The horizontal leg may provide an arm pivot hole 16 and an arcuate slot 18. The curvature of the arcuate slot 18 relative to the arm pivot hole 16 provides a constant radial distance therebetween that is equal to the distance between the bracket pivot hole 46 and the angle-adjustment hole 44.

A pivot fastener 24 operatively associates the arm pivot hole 16 and the bracket pivot hole 46, thereby allowing the angle bracket 38 to rotate about the pivot fastener 24 relative to the attachment arm plate 10. An adjustment handle 26 operatively associates the angle-adjustment hole 44 and innumerable positions along the arcuate slot 18. Which in turn makes the tilt table 30 attached to the first leg of the angle bracket 38 selectively adjustable relative to the underlying grinder 52 that the attachment arm plate 10 is mounted to. The angled bracket 38 may be locked in place by the adjustment handle 26, which may be a threaded lever.

The vertical leg may provide a first elevation-adjusting slot 12 spaced apart from a second elevation-adjusting slot 14, each generally parallel with each other and extending parallel to a longitudinal axis of the vertical leg. The first slot 12 may be narrower than the second slot 14. Each slot 12 and 14 are dimensioned to receive a first and second mounting fastener 20 and 22, respectively, for mounting the attachment arm plate 10 to structure 54 of the underlying grinder 52 at various relative elevations. Typically, the structure 54 is a tooling arm that are standard on grinders 52.

A method of assembling the present invention may include the following. The tilt table 30 may be fastened to the angle bracket 38 with sufficient square-up fasteners 48 to enable the use of the slide along lateral alignment slot 40 for lateral alignment with assistance of the lateral alignment fasteners 50. Once the tilt table 30 is squared up, it is locked into place with any remaining square-up fasteners 48. The angle bracket 38 may be attached to the attachment arm plate 10 with the pivot fastener 24 and the adjustment handle 26 as described above to select a bevel angle of incidence between the grinder belt 56 or 62 and the beveled edge 36. Such a desired bevel angle for the table 30 can be set and locked into position. The attachment arm plate 10 may be attached to the belt grinders tooling arm 54 at a selected vertical elevation relative to the tilt table 30 by way of the first and second elevation-adjusting slots 12 and 14.

The attachment arm plate 10 is used to interconnect the tilt table 30 to the grinders tooling arm 54. The attachment arm plate 10 has slots 12 and 14 which allow for vertical adjustment. This is important to locate the tilt table 30 at a desired height and for it to fit a variety of manufacturers grinders 52. The attachment arm plate 10 attaches to the angle bracket 38 with a pivot fastener 24 and lock down lever/adjustment handle 26. The adjustment handle 26 is used to lock table 30 at any desired bevel angle of incidence. The angle bracket 38 is used to attach table 30 to the attachment arm plate 10. Angle bracket 38 is also used in conjunction with fasteners to pivot and adjust the tilt table 30 so it can be squared to the work surface of the grinder 52. Once the tilt table 30 is squared achieving uniform bevels is much easier.

A method of using the present invention may include the following. Knife makers attach the tilt table 30 to grinders tooling arm 54. The assembly is then attached to the grinder 52. Vertical and horizontal adjustments are used to center the tilt table's top beveled edge 36 over the belt 56, 62. The angle bracket fasteners are loosened and the beveled surface 36 is help flush to the working surface of the grinder. The square-up fasteners 48 are adjusted to hold the tilt table 30 square and then the two lateral alignment fasteners 50 which attach the tilt table 30 to the angle bracket 38 are tightened. This allows for maximum horizontal flexibility and allows the tables top belt slot to be centered on a variety of different manufacturers grinders. The table 30 can easily be adjusted to any desired bevel angle of incidence.

Knife makers then hold the knife blank flat against the table and slowly move the blade upward into contact with the grinder. The blade is pulled from side to side while carefully keeping a visual eye on scribed lines on the blanks edge. The knife maker uses this visual reference to grind evenly the entire bevel. Once the bevel is finished on one side the blade to flipped and the process repeated to grind bevel on other side of the blade. Most knife bevels are rough ground with a coarse grit prior to heat treating. After heat treating the knife maker can clean up the bevels with a finer grit by keeping the tables angle set or using any commercially available angle gauge to reset the tilt table.

Although designed for knife makers that use belt grinders to grind a knifes bevels, the present invention could easily be adapted for stone grinding wheels or mounted to other types of grinders for beveling or sharpening chisels, axes or other tools.

It should be understood, of course, that the foregoing relates to exemplary embodiments of the invention and that modifications may be made without departing from the spirit and scope of the invention as set forth in the following claims.

What is claimed is:

1. An adjustable table assembly for supporting bevel grinding blanks, comprising:
an angle bracket comprising:
a first leg and a second leg oriented transverse the first leg;
along the first leg, a bracket pivot hole spaced apart from an adjustment hole by a first distance; and
longitudinally along the second leg, a lateral alignment slot an attachment arm plate comprising:
a vertical leg connected to a horizontal leg;
along the vertical leg, one or more vertical slots extending longitudinally along the vertical leg; and
along the horizontal leg, a plate pivot hole and an arcuate slot radially spaced apart from the plate pivot hole by the first distance; and
a tilt table extending between a tip edge and a lower edge, the tilt table comprising: a plurality of lateral alignment holes spaced apart inward of a lower edge of the tilt table.

2. The adjustable table assembly of claim 1 further comprising a belt cutout in a center of the tip edge.

3. The adjustable table assembly of claim 2 further comprising a beveled edge along a lower portion of the belt cutout.

4. The adjustable table assembly of claim 1 further comprising a pivot fastener interconnecting said pivot holes so that the angle bracket rotates relative the attachment arm plate about the pivot fastener.

5. The adjustable table assembly of claim 4 further comprising a lock down lever selectively securing one of a plurality of portions of the arcuate slot to the adjustment hole.

6. The adjustable table assembly of claim 1 further comprising one or more lateral alignment fasteners through the lateral alignment slot and operatively associating with one or more of the plurality of lateral alignment holes.

7. The adjustable table assembly of claim 1 further comprising:
a plurality of corner holes in the second leg; and
a plurality of square-up fasteners dimensioned to secure to an inner surface of the tilt table through the plurality of corner holes.

8. An adjustable table assembly for supporting bevel grinding blanks, comprising:
an angle bracket comprising:
a first leg and a second leg oriented transverse the first leg;
along the first leg, a bracket pivot hole spaced apart from an adjustment hole by a first distance; and
longitudinally along the second leg, a lateral alignment slot
an attachment arm plate comprising:
a vertical leg connected to a horizontal leg;
along the vertical leg, one or more vertical slots extending longitudinally along the vertical leg; and
along the horizontal leg, a plate pivot hole and an arcuate slot radially spaced apart from the plate pivot hole by the first distance; and
a tilt table comprising:
a tip edge and a lower edge opposing the tip edge;
a plurality of lateral alignment holes spaced apart inward of a lower edge of the tilt table;
a belt cutout in a center of the tip edge;
a beveled edge along a lower portion of the belt cutout;
a pivot fastener interconnecting said pivot holes so that the angle bracket rotates relative the attachment arm plate about the pivot fastener;
a lock down lever selectively securing one of a plurality of portions of the arcuate slot to the adjustment hole;
one or more lateral alignment fasteners through the lateral alignment slot and operatively associating with one or more of the plurality of lateral alignment holes;
a plurality of corner holes in the second leg; and
a plurality of square-up fasteners dimensioned to secure to an inner surface of the tilt table through the plurality of corner holes.
